(19) United States
(12) Patent Application Publication
(10) Pub. No.: US 2020/0094149 A1
(43) Pub. Date: Mar. 26, 2020

(54) SYSTEM AND METHOD FOR STREAMING ELECTRONIC SPORTS

(71) Applicant: Eric GONZALES, II, South San Francisco, CA (US)

(72) Inventor: Eric GONZALES, II, South San Francisco, CA (US)

(21) Appl. No.: 16/582,584

(22) Filed: Sep. 25, 2019

Related U.S. Application Data
(60) Provisional application No. 62/736,230, filed on Sep. 25, 2018.

(51) Int. Cl. A63F 13/86; G07F 17/32; H04N 21/2187; H04N 21/234

(52) U.S. Cl. CPC A63F 13/86; H04N 21/23424; H04N 21/2187; G07F 17/3288

(57) ABSTRACT

Methods, systems, and non-transitory computer-readable storage media for enabling multiple streaming options for an e-sports competition. A system can receive, from a first competitor, an e-sports challenge associated with a video game, and receive, from a second competitor, an acceptance of the e-sports challenge. As the competitors compete, the system can receive, from each competitor, a stream of that competitor's perspective. When others (such as an audience) wish to view the competition, they can view a stream of the first competitor's perspective, the second competitor's perspective, or a combination thereof.

### PRIORITY

The present disclosure claims priority to U.S. provisional patent application No. 62/736,230, filed Sep. 25, 2018, the contents of which are incorporated herein in their entirety.

### BACKGROUND

### 1. Technical Field

The present disclosure relates to electronic sports (“e-sports”), and more specifically to a platform for streaming electronic sports.

### 2. Introduction

E-sports, where individuals or teams compete against one another in different video games, often with an in-person or online audience, continue to gain in popularity. Many professional gamers have their own video channels on YouTube®, Twitch®, or other streaming platforms. Fans or spectators can use those video channels to watch video of the gamer as they compete online. However, these current platforms were built for streaming video from a single source, not for streaming e-sports to audience members who may be collectively interested in watching an e-sports contest but individually want to watch different aspects of that contest.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

An exemplary method performed by a system configured as disclosed herein can include: receiving, at a computer system from a first computing device of a first competitor, an e-sports challenge associated with a video game; receiving, at the computer system from a second computing device of a second competitor, an acceptance of the e-sports challenge; receiving, at the computer system from the first competitor, a first competitor stream of a competition between the first competitor and the second competitor, the competition being to satisfy the e-sports challenge, the first competitor stream being from a first perspective belonging to the first computing device of the first competitor; receiving, at the computer system from the second competitor, a second competitor stream of the competition from a second perspective belonging to the second computing device of the second competitor; and receiving, from an audience computing device of an audience member, a request to view at least one of the first competitor stream, the second competitor stream, or a combination thereof.

An exemplary system configured as disclosed herein can include: a processor; and a non-transitory computer-readable storage medium having instructions stored which, when executed by the processor, cause the processor to perform operations comprising: receiving, from a first computing device of a first competitor, an e-sports challenge associated with a video game; receiving, from a second computing device of a second competitor, an acceptance of the e-sports challenge; receiving, from the first competitor, a first competitor stream of a competition between the first competitor and the second competitor, the competition being to satisfy the e-sports challenge, the first competitor stream being from a first perspective belonging to the first computing device of the first competitor; receiving, from the second competitor, a second competitor stream of the competition from a second perspective belonging to the second computing device of the second competitor; and receiving, from an audience computing device of an audience member, a request to view at least one of the first competitor stream, the second competitor stream, or a combination thereof.

An exemplary non-transitory computer-readable storage medium configured as disclosed herein can have instructions stored which, when executed a processor, cause the processor to perform operations which include: receiving, from a first computing device of a first competitor, an e-sports challenge associated with a video game; receiving, from a second computing device of a second competitor, an acceptance of the e-sports challenge; receiving, from the first competitor, a first competitor stream of a competition between the first competitor and the second competitor, the competition being to satisfy the e-sports challenge, the first competitor stream being from a first perspective belonging to the first computing device of the first competitor; receiving, from the second competitor, a second competitor stream of the competition from a second perspective belonging to the second computing device of the second competitor; and receiving, from an audience computing device of an audience member, a request to view at least one of the first competitor stream, the second competitor stream, or a combination thereof.

### BRIEF DESCRIPTION OF THE DRAWINGS

FIG. 1 illustrates an example of two gamers initiating an e-sports match;

FIG. 2 illustrates broadcasting an e-sports competition to an audience;

FIG. 3 illustrates varying commercials within an e-sports competition;

FIG. 4 illustrates an example method claim; and

FIG. 5 illustrates an example computer system.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure.

The disclosed e-sports gaming platform allows audience members to (1) control how they watch competitors, and (2) follow and receive notifications regarding individual competitors. In addition, the disclosed e-sports gaming platform can allow competitors to (1) have wallets associated with their accounts for winnings, wagering, and collecting revenue from commercials broadcast during their streams; and (2) interact with followers, competitions, teammates, clans, etc. Furthermore, the platform allows for unique gaming challenges and competitions not previously seen in e-sports. While specific examples may be provided herein, the concepts and principles from any example can be combined and/or modified with those of other examples as required by a particular configuration.

The disclosed platform allows players (or teams) to generate challenges to compete in video games against other players. A wager can be placed on the game, such as “The winner receives $5.” In some configurations there can be no limits to the size or amount of the wager, such that wagers of one cent or thousands of dollars are both viable wagers. In other configurations there can be limits to the wager placed. These wager limits can, for example, be based on the experience of the competitor, the age of the competitor, amount of money in a competitor's online account (“wallet”), a degree of skill assigned to the competitor, etc. The player creating a challenge can, for example, select a game and set a wager or challenge for other competitors. For example, the player may post a challenge for $5 on a particular game, such that other players can accept the $5 challenge. Once a challenge has been accepted, the two players compete, with the winner receiving $5 and the loser paying $5. This concept, of setting wagers and competing for the associated winnings, can likewise apply to team competitions. For example, a team (or clan) can set challenges, accept other challenges, etc.

Players or competitors using the system disclosed herein can include an individual, a team, or a clan. Unless otherwise indicated, examples or disclosure related to a player or a competitor can be applied to teams or clans.

For each player, a profile page can be created. This page can include information about the player, such as gamertags (similar to a call sign, the online name by which the player is known or found) for one or more gaming systems, competitive record, teammates, upcoming events, open challenges, etc. The page can also include videos of previous competition and/or video of live competition. For example, if the player is currently engaged in a live competition, the player's page can have a video feed of the player's screen, such that visitors to the player's page (an audience) can watch a live video feed of the player competing. This video feed may or may not be combined with an audio channel of the player which allows an audience member to hear the player speaking or talking during the video feed.

As an audience watches the video feed, the system can introduce commercials into the video feed. In some configurations, the commercial can occur between portions of the match. For example, the system can detect an intermission within the competitive match and inject a commercial into that intermission. In other configurations, the commercial can be a banner ad, such that the entirety of the video feed is not covered with an advertisement (thereby allowing the audience to continue viewing the competition). In yet other configurations, the commercial injected into the video feed can be a complete video replacement, such that for the period of time of the commercial the audience would be incapable of viewing the competition.

The timing of the commercials presented on competitor's feeds can also vary. In some cases, the commercials can be presented within a window (e.g., between every 10 and 15 minutes), but when the commercial is presented within that window is randomly determined by the system. In other configurations, the timing for the commercials can be fixed, such that a commercial appears periodically at set intervals. In some cases, a commercial can be presented on player A's feed while no commercial appears on player B's feed, and vice versa.

Within a match, the commercials presented can vary from player to player. For example, if a player “A” and player “B” were competing, and an audience member was viewing the feed of player “A,” that audience member may view entirely distinct commercials than if the audience member were viewing the feed of player “B.” In some configurations, the commercial selection is based on the individual competitor being watched. For example, if the competitor has a large number of followers, certain advertisers may select to advertise on that competitor's page, whereas if the competitor has a smaller number of followers distinct advertisers may select to advertise on the competitor's page. In other configurations, the commercial selection can be based on the audience member watching the competition. That is, the commercials seen by a particular audience member can be selected based on characteristics (such as viewing habits, demographics, Internet cookies, etc.) of the viewing audience member. In yet other configurations, the commercials can be based on a hybrid of information about both the competitor and the audience member.

Because each player has a wallet where their winnings can be deposited and their payouts withdrawn, this system allows for players to receive payment for the advertising which occurs on their video stream. The amount of the payout for an advertisement can be based on the number of viewers of the advertisement, the level of competition, how notorious or proficient the player is, time of day, day of the week, etc. For example, a certain player may be given extra advertising premiums when playing (and having advertisements viewed) on a Thursday (i.e., before the weekend) because then audience members will see the advertisements before shopping over the weekend. Unlike existing streaming systems, such as Twitch® or YouTube®, players using the current system would not have restrictions on a minimum number of views before initiating advertising payouts. While the payouts may be small for new players, or players without a reputation, the small payouts will nevertheless be paid to the player's wallets.

The platform as a whole can sell merchandise to players, audience members, or fans/shoppers in general. In such cases, the platform management would obtain the profit of the sales from an individual player's page. The player page can also provide a mechanism for the players, teams, or clans to collect revenue from merchandise. For example, as part of the requirement for joining a clan, a clan can require a percentage of any sales made on an individual member of the clan's personal page, or the clan may have a clan page. In addition, certain configurations can provide an option to provide a percentage of any merchandise sold through the player's page to the player's wallet, such that the player can directly profit from their popularity. Similarly, the player can have gear sold bearing their gamertags, clan names, etc., sell those through the player's page (or the clan's page) on the platform, and receive a percentage of that sale. The percentage of profit an individual player makes of sales on their page can increase based on the amount of sales/volume/transactions they are enabling. That is, as a player sells more merchandise through their page, the percentage of profit from that transaction can rise.

While the examples provided thus far concern competition, the player's stream on their page can also be of them playing a game alone, or teamed up with another player or players in a cooperative game (such as a PvE (player versus environment) game, as opposed to a PvP (player versus player) game). In other words, the same stream that can be used to show a player competing against other players can be used to show the player playing a game alone, teaming up with other players, etc. The same ability to be paid for commercials, etc., can be present in such non-competitive streams.

Audience members can select which players to watch, either by selecting a lobby for a particular competition or going to a particular player's page. If the audience member goes to a player's page, they can be potentially be presented with options (as described above) to view a live feed of the player currently competing or playing, pre-recorded videos of the player competing or playing, an option to purchase player-associated merchandise, and/or an option to “follow” the player. The option to follow the player could include, for example, the ability to receive notifications when the player begins a stream (competitive or otherwise), posts a challenge, accepts a challenge, etc.

When an audience member selects the lobby for a particular event (such as a competition between players, or a cooperative event involving more than one player), the audience member can be presented with the option to go to any of the individual player's pages. The audience member can also be presented with the option of viewing, simultaneously, the feeds of more than one screen of the participating players. For example, if two players (players A and B) are competing, the audience member can be provided the option to view the screen of player A, the screen of player B, and/or both the screens of player A and B simultaneously. Audio feeds provided to the audience member can likewise be selected from the various players. The number of streams which can be combined (e.g., 1v1, 16v16, etc.) is not limited.

In addition to the ability to foster/encourage challenges, the system allow individuals or teams to stream PvE experiences, and other streaming options discussed above, the disclosed system can also be used for tournaments. For example, the system can be used to organize a tiered tournament and send notifications to followers of the tournament regarding when the matches will be occurring. The system can also be used to organize a “You versus the World” deathmatch, where at each level the players can be provided the option to take their winnings and withdraw, or continue on with the risk of losing their winnings. For example, a first round of such a tournament could cost $1 to enter, and if a player wins they can recover the $1 (if they lose they're out of the tournament). At that point they can take the $1 and withdraw from the tournament, or they continue to the next level of the tournament. Eventually, the player may be offered large sums of money, at which point they will be forced to decide if they are going to take the money or continue. In some cases, challenges, games, and/or tournaments can be sponsored, in which case there may be no chance of losing an initial investment, and the player who keeps winning only needs to decide at what point they are going to take the money and walk away.

In some configurations, representatives of the platform or system can be required to participate in games or tournaments to ensure integrity of the contest. In such cases, if the representative were to receive winnings, the system can automatically donate those winnings to a designated charity.

As players compete in games, challenges, and tournaments, they can be ranked both according to a world-wide standing, as well as based on considerations such as country, age, skill level, etc. In some cases, special tournaments can be organized based on player country (similar to an e-sports Olympics), where the best from each country play one another.

The systems and principles disclosed herein can be based on any system (Personal Computer (“PC”), Xbox®, PlayStation®, Nintendo® consoles, etc.). In one configuration, the system is completely separate from the PC or console, and instead operates as a website. In such configurations, both audience members and players/competitors can log into the website and find respective activities they wish to participate in. For example, players can identify challenges they wish to participate in and audience members can identify players or event lobbies they wish to interact with. As the audience members open the lobby of an event or the page of a particular player, they can select to view associated video feeds of that player. As the player selects challenges, tournaments, etc., they can enter their gamer tag information (or it can be pre-selected), such that the system knows that the person associated with a given gamer tag is participating. In some configurations, the disclosed platform can be accessed directly from a console such as an Xbox®, Playstation®, or other console. In that case, the console can be equipped to link video from the game to the player's video stream.

In some cases, a co-located event (such as a tournament) can occur within a stadium, arena, or other venue. In such cases, specific lobbies within the platform can be designated for the event competitors. Physically, the competitors can each have an individual console which connects to a personal screen, where the personal screen can be shared as needed with projectors and other media both within the stadium and online. For example, each competitor can use a screen built into (or attached to) the back of the seat immediately in front of them (similar to television monitors on airplanes). As a player is playing, the player's screen may be accessed online by the player's followers and/or by media personnel within the arena. The console can plug into the respective seat in a modular fashion, such that the type of console being used in the seat can be exchanged as needed.

As competitors, potential competitors, and audience members interact on one another's pages (both during and outside of competition), the system allows those users to generate tips, provide commentary, chat and otherwise communicate in a lobby which is found on a player's page.

In some configurations, tournaments can be configured such that, as an audience member interacts (e.g., clicks) on a portion of a computer-displayed bracket, the system identifies the players currently participating in that portion of the bracket, then transmits the corresponding streams for those players to the audience member's computing device, such that the bracket is now displaying the live competition for that portion of the tournament.

The system can be configured to require special memberships for celebrity tournaments, etc., where access to the pages and streams of certain members requires additional payments from audience members. The additional payments can go directly to those “special” members, or portions of those additional payments can go to system management, sponsors, as well as the “special” members.

From a respective console or PC, the video stream being displayed to the user is captured and filtered, such that the level of resolution of the streams being viewed can vary from audience member to audience member. That is, if a first audience member only has the bandwidth to watch the stream in 720p, and a second audience member has the bandwidth to watch the stream in 4k (4320p), the system can provide the desired resolution to each respective audience member. That is, the same content can be simultaneously streamed/transmitted at different resolutions to different audience members.

In addition, if a competitor is uploading their stream to YouTube® or other web-based video service, the system can download or otherwise access the stream from the web-based video service either during the stream or after the stream, then save the video in question in a separate database organized by the wager, competition, or other indexing system, thereby allowing the video to be easily accessed in the future. This provides a mechanism for ensuring correct payment, and discouraging cheating or other bad behavior.

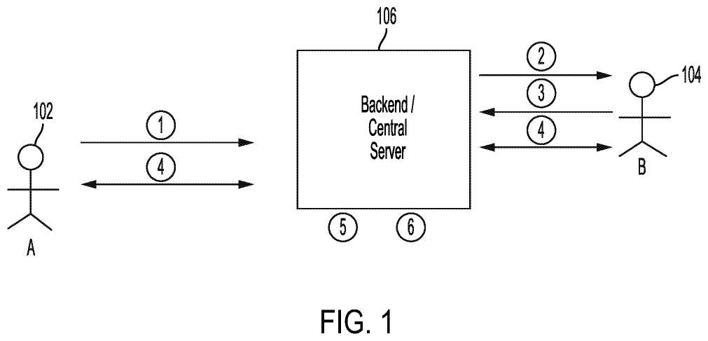

Having described the overall system generally, the disclosure now turns to the examples provided by the figures. FIG. 1 illustrates an example of two gamers 102, 104 initiating an e-sports match. In this example, player A 102 sets a challenge amount (1) for a game. This challenge is sent to a backend/central server 106, which receives the challenge and broadcasts it to other players. Player B 104 sees player A′s challenge (2) and accepts the challenge (3). Player A and B play against one another, as verified by the server (4), with a record of the match made by one or both players. The copy of the match is saved on the backend/central server 106 (5), and the central server modifies the wallets/winnings of the players based on the match outcome (6).

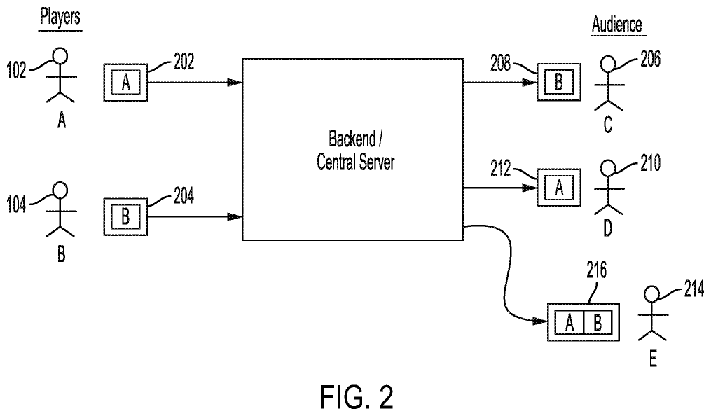

FIG. 2 illustrates broadcasting an e-sports competition to an audience. In this example, two players, player A 102 and player B 104, have decided to compete against one another. The player A's screen 202 and player B's screen 204 are transmitted to the backend/central server 106. The audience can choose to view one or both of the screens of the players. For example, audience member C 206 has selected to view player B's screen 208, 204. Audience member D 210 has selected to view player A's screen 212, 202, and audience member E 214 has selected to view both player A and player B's screens simultaneously 216, 202, 204. In this manner, the audience members can select, in real-time, which screen (the screen of player A 202 or the screen of player B 204) to view. The backend/central server 106 can switch, combine, and/or remove screens for individual audience members 206, 210, 214 upon receiving input from the audience member regarding which screens they wish to view.

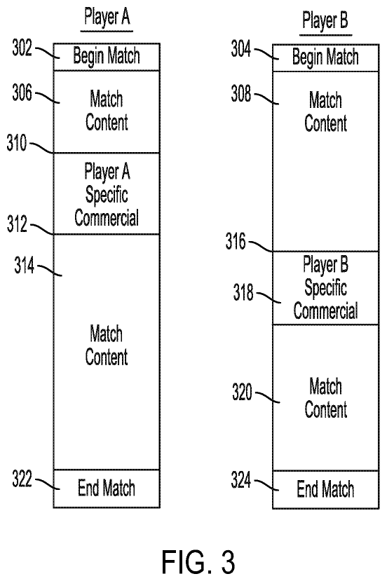

FIG. 3 illustrates varying commercials within an e-sports competition. In this example, players A and B begin a match (or event) at the same time 302, 304. As the match begins, the respective streams for players A and B begin streaming match content 306, 308 from the perspectives of player A and B. However, at a given point 310 a commercial which is specific to player A begins while the match content continues to stream 308 on player B's feed. Upon finishing the commercial 312, player A's stream once again plays the match content 314. Meanwhile, a commercial specific to player B initiates 316, ends 318, and the player B stream continues broadcasting the match content from player B's perspective 320. This process (that of commercials which are unique to the respective player's streams) can continue until the match ends 322, 324. As discussed above, the commercials presented on each player's feed can be complete video replacements, banners, etc., and may or may not disrupt viewing of the feed. The type of commercial can be based on a live viewing versus a pre-recorded video, demographic of the audience, etc.

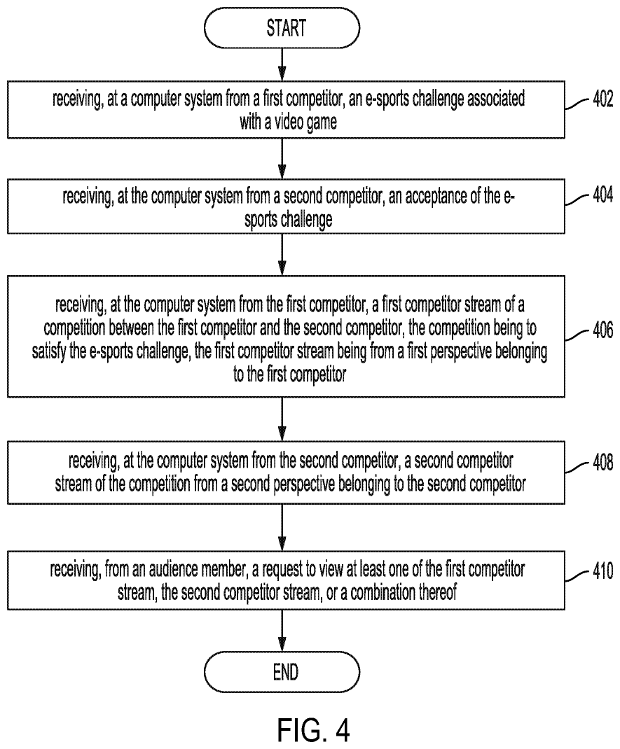

FIG. 4 illustrates an example method claim which can be performed by a system, such as a server or other computing system, configured as described herein. In this example, the system receives, from a first competitor (or more specifically, a computing device of the first competitor), an e-sports challenge associated with a video game (402). The system also receives, from a second competitor (or more specifically, a computing device of the second competitor), an acceptance of the e-sports challenge (404). The system then receives, from the first competitor, a first competitor stream of a competition between the first competitor and the second competitor, the competition being to satisfy the e-sports challenge, the first competitor stream being from a first perspective of the first competitor (406), the first perspective being the perspective displayed to the first competitor on the first computing device. The system also receives, from the second competitor, a second competitor stream of the competition from a second perspective of the second competitor (408), the second perspective being the perspective displayed to the second competitor on the second computing device. The system then receives, from an audience member (or more specifically, a computing device of an audience member), a request to view at least one of the first competitor stream, the second competitor stream, or a combination thereof (410).

In some configurations, the e-sports challenge is a wager amount in a currency. For example, the first competitor can issue a challenge to others for $1, with the promise that if the first competitor loses to a challenger who accepts the wager, the first competitor will pay the challenger a dollar, whereas if the first competitor wins against a challenger the challenger will pay the first competitor a dollar. In some configurations, audience members can create wagers with other audience members, or with competitors, regarding the outcome of a competition. For example, in one scenario two audience members may create a wager over a competition between two competitors (who are not the audience members making the wager). In another example, a competitor may create a wager against both another competitor as well as audience members. For instance, competitor A may wager $1 against competitor B over a video game competition, but competitor A may also wager $1 against audience member C that he (competitor A) will win against competitor B.

In some configurations, the method can further include transmitting, in response to the audience member, a first stream to the audience computing device; receiving, from a second audience computing device of a second audience member, a second request from a to view only the first competitor stream; transmitting, in response to the second request, the first competitor stream to the second audience computing device as a second stream; receiving, from a third audience computing device of a third audience member, a second request from a to view only the second competitor stream; transmitting, in response to the third request, the second competitor stream to the second audience computing device as a third stream; receiving, from a fourth audience computing device of a fourth audience member, a fourth request from a to view both the first competitor stream and the second competitor stream simultaneously; and transmitting, in response to the fourth request, a combination of the first competitor stream and the second competitor stream as a forth stream to the fourth audience computing device. In such configurations, at least one of advertisements or commercials can be inserted into the first stream, the second stream, the third stream, and the fourth stream. The inserted advertisements or commercials can be inserted at distinct points within the respective streams such that the at least one of advertisements or commercials are displayed on the audience computing device, the second audience computing device, the third audience computing device, and the forth audience computing device at distinct times while the competition is ongoing. The inserted advertisements or commercials can include a banner advertisement which covers a portion of a respective stream of the competition, a video commercial which covers at least a portion of a respective stream of the competition, or any combination thereof.

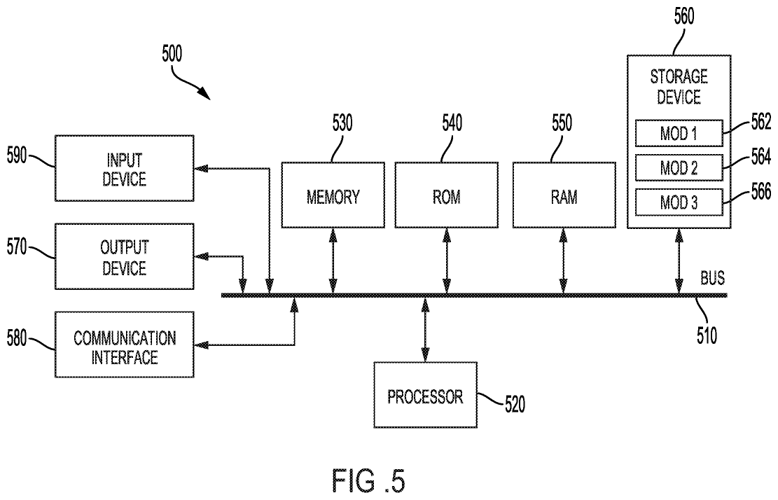

With reference to FIG. 5, an exemplary system includes a general-purpose computing device 500, including a processing unit (CPU or processor) 520 and a system bus 510 that couples various system components including the system memory 530 such as read-only memory (ROM) 540 and random access memory (RAM) 550 to the processor 520. The system 500 can include a cache of high-speed memory connected directly with, in close proximity to, or integrated as part of the processor 520. The system 500 copies data from the memory 530 and/or the storage device 560 to the cache for quick access by the processor 520. In this way, the cache provides a performance boost that avoids processor 520 delays while waiting for data. These and other modules can control or be configured to control the processor 520 to perform various actions. Other system memory 530 may be available for use as well. The memory 530 can include multiple different types of memory with different performance characteristics. It can be appreciated that the disclosure may operate on a computing device 500 with more than one processor 520 or on a group or cluster of computing devices networked together to provide greater processing capability. The processor 520 can include any general purpose processor and a hardware module or software module, such as module 1 562, module 2 564, and module 3 566 stored in storage device 560, configured to control the processor 520 as well as a special-purpose processor where software instructions are incorporated into the actual processor design. The processor 520 may essentially be a completely self-contained computing system, containing multiple cores or processors, a bus, memory controller, cache, etc. A multi-core processor may be symmetric or asymmetric.

The system bus 510 may be any of several types of bus structures including a memory bus or memory controller, a peripheral bus, and a local bus using any of a variety of bus architectures. A basic input/output (BIOS) stored in ROM 540 or the like, may provide the basic routine that helps to transfer information between elements within the computing device 500, such as during start-up. The computing device 500 further includes storage devices 560 such as a hard disk drive, a magnetic disk drive, an optical disk drive, tape drive or the like. The storage device 560 can include software modules 562, 564, 566 for controlling the processor 520. Other hardware or software modules are contemplated. The storage device 560 is connected to the system bus 510 by a drive interface. The drives and the associated computer-readable storage media provide nonvolatile storage of computer-readable instructions, data structures, program modules and other data for the computing device 500. In one aspect, a hardware module that performs a particular function includes the software component stored in a tangible computer-readable storage medium in connection with the necessary hardware components, such as the processor 520, bus 510, display 570, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 500 is a small, handheld computing device, a desktop computer, or a computer server.

Although the exemplary embodiment described herein employs the hard disk 560, other types of computer-readable media which can store data that are accessible by a computer, such as magnetic cassettes, flash memory cards, digital versatile disks, cartridges, random access memories (RAMs) 550, and read-only memory (ROM) 540, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 590 represents any number of input mechanisms, such as a microphone for speech, a touch-sensitive screen for gesture or graphical input, keyboard, mouse, motion input, speech and so forth. An output device 570 can also be one or more of a number of output mechanisms known to those of skill in the art. In some instances, multimodal systems enable a user to provide multiple types of input to communicate with the computing device 500. The communications interface 580 generally governs and manages the user input and system output. There is no restriction on operating on any particular hardware arrangement and therefore the basic features here may easily be substituted for improved hardware or firmware arrangements as they are developed.

The steps outlined herein are exemplary and can be implemented in any combination thereof, including combinations that exclude, add, or modify certain steps.

Use of language such as “at least one of X, Y, and Z” or “at least one or more of X, Y, or Z” are intended to convey a single item (just X, or just Y, or just Z) or multiple items (i.e., {X and Y}, {Y and Z}, or {X, Y, and Z}). “At least one of” is not intended to convey a requirement that each possible item must be present.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method comprising:
receiving, at a computer system from a first computing device of a first competitor, an e-sports challenge associated with a video game;
receiving, at the computer system from a second computing device of a second competitor, an acceptance of the e-sports challenge;
receiving, at the computer system from the first competitor, a first competitor stream of a competition between the first competitor and the second competitor, the competition being to satisfy the e-sports challenge, the first competitor stream being from a first perspective belonging to the first computing device of the first competitor;
receiving, at the computer system from the second competitor, a second competitor stream of the competition from a second perspective belonging to the second computing device of the second competitor; and
receiving, from an audience computing device of an audience member, a request to view at least one of the first competitor stream, the second competitor stream, or a combination thereof.

2. The method of claim 1, wherein the e-sports challenge comprises a wager amount in a currency.

3. The method of claim 1, further comprising:
transmitting, in response to the audience member, a first stream to the audience computing device;
receiving, from a second audience computing device of a second audience member, a second request from a to view only the first competitor stream;
transmitting, in response to the second request, the first competitor stream to the second audience computing device as a second stream;
receiving, from a third audience computing device of a third audience member, a second request from a to view only the second competitor stream;
transmitting, in response to the third request, the second competitor stream to the second audience computing device as a third stream;
receiving, from a fourth audience computing device of a fourth audience member, a fourth request from a to view both the first competitor stream and the second competitor stream simultaneously; and
transmitting, in response to the fourth request, a combination of the first competitor stream and the second competitor stream as a forth stream to the fourth audience computing device.

4. The method of claim 3, wherein at least one of advertisements or commercials are inserted into the first stream, the second stream, the third stream, and the fourth stream.

5. The method of claim 4, wherein the at least one of advertisements or commercials are inserted at distinct points within the respective streams such that the at least one of advertisements or commercials are displayed on the audience computing device, the second audience computing device, the third audience computing device, and the forth audience computing device at distinct times while the competition is ongoing.

6. The method of claim 4, wherein the at least one of advertisements or commercials comprises a banner advertisement which covers a portion of a respective stream of the competition.

7. The method of claim 4, wherein the at least one of advertisements or commercials comprises a video commercial which covers at least a portion of a respective stream of the competition.

8. A system comprising:
a processor; and
a non-transitory computer-readable storage medium having instructions stored which, when executed by the processor, cause the processor to perform operations comprising:
receiving, from a first computing device of a first competitor, an e-sports challenge associated with a video game;
receiving, from a second computing device of a second competitor, an acceptance of the e-sports challenge;
receiving, from the first competitor, a first competitor stream of a competition between the first competitor and the second competitor, the competition being to satisfy the e-sports challenge, the first competitor stream being from a first perspective belonging to the first computing device of the first competitor;
receiving, from the second competitor, a second competitor stream of the competition from a second perspective belonging to the second computing device of the second competitor; and
receiving, from an audience computing device of an audience member, a request to view at least one of the first competitor stream, the second competitor stream, or a combination thereof.

9. The system of claim 8, wherein the e-sports challenge comprises a wager amount in a currency.

10. The system of claim 8, the non-transitory computer-readable storage medium having additional instructions stored which, when executed by the processor, cause the processor to perform operations comprising:
transmitting, in response to the audience member, a first stream to the audience computing device;
receiving, from a second audience computing device of a second audience member, a second request from a to view only the first competitor stream;
transmitting, in response to the second request, the first competitor stream to the second audience computing device as a second stream;
receiving, from a third audience computing device of a third audience member, a second request from a to view only the second competitor stream;
transmitting, in response to the third request, the second competitor stream to the second audience computing device as a third stream;
receiving, from a fourth audience computing device of a fourth audience member, a fourth request from a to view both the first competitor stream and the second competitor stream simultaneously; and
transmitting, in response to the fourth request, a combination of the first competitor stream and the second competitor stream as a forth stream to the fourth audience computing device.

11. The system of claim 10, wherein at least one of advertisements or commercials are inserted into the first stream, the second stream, the third stream, and the fourth stream.

12. The system of claim 11, wherein the at least one of advertisements or commercials are inserted at distinct points within the respective streams such that the at least one of advertisements or commercials are displayed on the audience computing device, the second audience computing device, the third audience computing device, and the forth audience computing device at distinct times while the competition is ongoing.

13. The system of claim 11, wherein the at least one of advertisements or commercials comprises a banner advertisement which covers a portion of a respective stream of the competition.

14. The system of claim 11, wherein the at least one of advertisements or commercials comprises a video commercial which covers at least a portion of a respective stream of the competition.

15. A non-transitory computer-readable storage medium having instructions stored which, when executed by a processor, cause the processor to perform operations comprising:
receiving, from a first computing device of a first competitor, an e-sports challenge associated with a video game;
receiving, from a second computing device of a second competitor, an acceptance of the e-sports challenge;
receiving, from the first competitor, a first competitor stream of a competition between the first competitor and the second competitor, the competition being to satisfy the e-sports challenge, the first competitor stream being from a first perspective belonging to the first computing device of the first competitor;
receiving, from the second competitor, a second competitor stream of the competition from a second perspective belonging to the second computing device of the second competitor; and
receiving, from an audience computing device of an audience member, a request to view at least one of the first competitor stream, the second competitor stream, or a combination thereof.

16. The non-transitory computer-readable storage medium of claim 15, wherein the e-sports challenge comprises a wager amount in a currency.

17. The non-transitory computer-readable storage medium of claim 15, having additional instructions stored which, when executed by the processor, cause the processor to perform operations comprising:
transmitting, in response to the audience member, a first stream to the audience computing device;
receiving, from a second audience computing device of a second audience member, a second request from a to view only the first competitor stream;
transmitting, in response to the second request, the first competitor stream to the second audience computing device as a second stream;
receiving, from a third audience computing device of a third audience member, a second request from a to view only the second competitor stream;
transmitting, in response to the third request, the second competitor stream to the second audience computing device as a third stream;
receiving, from a fourth audience computing device of a fourth audience member, a fourth request from a to view both the first competitor stream and the second competitor stream simultaneously; and
transmitting, in response to the fourth request, a combination of the first competitor stream and the second competitor stream as a forth stream to the fourth audience computing device.

18. The non-transitory computer-readable storage medium of claim 17, wherein at least one of advertisements or commercials are inserted into the first stream, the second stream, the third stream, and the fourth stream.

19. The non-transitory computer-readable storage medium of claim 17, wherein the at least one of advertisements or commercials are inserted at distinct points within the respective streams such that the at least one of advertisements or commercials are displayed on the audience computing device, the second audience computing device, the third audience computing device, and the forth audience computing device at distinct times while the competition is ongoing.

20. The non-transitory computer-readable storage medium of claim 17, wherein the at least one of advertisements or commercials comprises a banner advertisement which covers a portion of a respective stream of the competition.
